(19) United States
(12) Patent Application Publication
(10) Pub. No.: US 2009/0089865 A1
(43) Pub. Date: Apr. 2, 2009

(54) NETWORK ACCESS AND PROFILE CONTROL

(75) Inventors: Andrew Baron, Redmond, WA (US); Taroon Mandhana, Redmond, WA (US); Amir Zohrenejad, Seattle, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/865,984

(22) Filed: Oct. 2, 2007

(51) Int. Cl. G06F 21/00

(52) U.S. Cl. 726/6

(57) ABSTRACT

A method and apparatus for managing network profiles and/or access to a network. Network profiles stored in a computer may be deleted and/or a connection to a wireless network may be disabled when a corresponding access period for the network has been exhausted. The access period may define an amount of time, a number of connections, a number of bits or packets of information, or other measure of connectivity to a network and/or maintenance of profile information related to the network that may be limited in some fashion.

### BACKGROUND

1. Field of Invention

This invention relates to controlling access to a network and/or controlling stored network profiling information, e.g., information used to establish a connection with a wireless network.

2. Related Art

When connecting to a wireless network, such as a wireless network operating according to the IEEE 802.11 standard, client machines need certain parameters regarding the configuration settings of the network. A client machine may obtain this information in the process of establishing a connection with the network, and save the information for later use when reconnecting to the same network. These settings are commonly referred to as network profiles and are usually stored on the client machine indefinitely.

### SUMMARY OF INVENTION

The inventors have appreciated that although storing network profiles on client machines for indefinite periods of time may work well for users that regularly and repeatedly connect to a limited number of networks, problems can arise for users that connect to many different networks. For example, some users of laptop computers may connect to several different wireless networks in a single day, many of which the user may never again use. The end result is that highly mobile users may have hundreds of network profiles stored on their computers. In some cases this can cause problems, for example where the computer detects the presence of a network having the same name as that in one of the stored network profiles, and in response connects to the network. However, many wireless networks are established with the same network name (such as the manufacturer name or model of the router), and thus the computer may connect to an unknown or unwanted network. Connection to such networks may jeopardize the security of the computer, especially if the network is being operated by a person seeking to gain unauthorized access to machines that connect to the network.

In another example, when users establish an adhoc peer-to-peer network, a network profile may be stored, and when the computer is not connected to the network, the computer may continuously beacon in an effort to reestablish contact with the network. This beaconing can be exploited by malicious users, e.g., by acting as another machine in the network and gaining access to the computer or receiving sensitive information. In another example, when a computer beacons to join a network, the beacon signal may include the name of the network that the computer is seeking to connect to. A malicious user may use this information to spoof the network, causing the computer to establish a connection in an unwanted way. A large set of stored network profiles may also slow down the computer's ability to connect to a suitable network, since the computer may cycle through a long list of “preferred” networks in an attempt to connect before finding an appropriate network.

Aspects of the invention provide for the establishment of an access period for each network profile stored on a client machine, such as a computer, personal digital assistant (PDA), cellular telephone, laptop computer, or other suitable device. (Such devices are referred to collectively herein as a “computer.”) The access period may define an interval (such as a period of time, expiration date, number of connections, number of bits, packets, or other units of information sent and/or received over the network, or other) over which the computer may connect to the network and/or after which the stored network profile is deleted. For example, in one embodiment, a network profile that is stored after an initial connection to a network may be deleted from the computer if the computer does not again establish a connection to the network within a certain number of days, weeks, years or other time period. Thus, the computer need not necessarily retain network profiles for networks longer than a specified period, such as two months, if no intervening connection to the network is made. However, if the computer establishes a connection to a network within the two month period, the access period may be reset, causing the computer to retain the network profile for at least another two months.

In another embodiment, exhaustion of the access period may cause the computer to disconnect from the network. For example, after establishing a connection with an adhoc peer-to-peer network and communicating in the network, the computer may be permitted to attempt to maintain a connection with the network for a certain period of time after the last peer in the network leaves. However, after the specified time period passes, the computer may be caused to automatically terminate further participation in the network. For example, after the last peer leaves a network, the computer may be permitted to attempt reconnection for another ten minutes. Thereafter, the computer may be prevented from attempting to establish further connection. In addition, or alternately, a network profile stored for the peer-to-peer network may be deleted once the access period has expired. Deletion of the network profile may essentially prevent the computer from attempting reestablishment of the connection to the network, since information needed for reconnection attempts may no longer be accessible to the computer.

In another embodiment, a network profile and corresponding access period may be established to provide a computer with temporary access to a network, e.g., to allow a visitor temporary access to the network that effectively expires when the visitor departs. For example, a network administrator may push a network profile along with a corresponding access period to a computer via a wired connection to the computer. The network profile may include information that enables the computer to connect with a wireless network under the control of the administrator. Thus, the computer, using the network profile received from the administrator, may establish a connection with the wireless network until the access period provided with the network profile is exhausted. Upon exhaustion of the access period, the network profile may be deleted and/or the computer may be caused to automatically disconnect from the network.

In one aspect of the invention, a method for managing wireless network profiles includes providing a computer constructed and arranged to communicate wirelessly with at least one other device in a wireless network, and storing one or more network profiles in a memory of the computer. Each network profile may include information regarding a corresponding wireless network that the computer has communicated with or is intended to communicate with and include at least a network name and a security setting of the wireless network. Information in the network profile may be used by the computer in initiating a connection with the corresponding wireless network. An access period may be established over which each of the network profiles will be maintained in the memory of the computer, and at least one network profile may be deleted and/or a connection to the corresponding wireless network may be disabled when a corresponding access period for the network profile has been exhausted.

In another aspect of the invention, a computer readable medium may include instructions that, when executed on a computer system, causes the computer system to perform a method for managing network access. One or more network profiles may be stored in the memory of the computer system, where each network profile includes information regarding a corresponding wireless network that the computer has communicated with or is intended to communicate with and includes at least a network name and a security setting of the network. Information in the network profile may be used by the computer in initiating a connection with the corresponding wireless network. An access period may be established over which each of the network profiles will be maintained in the memory of the computer, and at least one network profile may be deleted and/or a connection to the corresponding wireless network may be disabled when a corresponding access period for the network profile has been exhausted.

In another aspect of the invention, a computer includes a radio constructed and arranged to communicate with a wireless network, and a memory storing one or more network profiles. Each network profile may include information regarding a corresponding wireless network that the computer has communicated with or is intended to communicate with and include at least a network name and a security setting of the network. Information in the network provide may be useable by the computer in initiating a connection with the corresponding network. A connection engine may delete a network profile in the memory and/or disable the radio from communicating with a network that corresponds to a network profile in the memory if an access period for the network has been exhausted.

These and other aspects of the invention will be apparent from the following detailed description and claims.

### BRIEF DESCRIPTION OF THE DRAWINGS

Aspects of the invention are described with reference to illustrative embodiments and the following drawings in which like numerals reference like elements, and wherein:

FIG. 1 shows a schematic block diagram of a computer arranged in accordance with aspects of the invention and illustrative networks to which the computer may connect;

FIG. 2 is a flow chart of steps in a method for managing network profiles and/or network connectivity; and

FIG. 3 shows steps in a method for managing an access period in a peer-to-peer network.

### DETAILED DESCRIPTION

Aspects of the invention are described below with reference to illustrative embodiments. However, it should be appreciated that aspects of the invention are not limited to any of the particular embodiments. For example, examples are provided below regarding communication of a computer with one or more wireless networks. However, it should be appreciated that aspects of the invention may be employed in environments in which the computer communicates with one or more wired networks or other arrangements. In addition, the examples below include the computer acting as a client within the network. However, it should be understood that the computer may function as an access point or other similar device in a network, as well as functioning as a client in one or more other networks. Also, as mentioned above, illustrative embodiments are described using the term “computer” to refer to the device on which network profiles or other network access parameters are managed. However, it should be understood that the term computer as used herein may refer to a general purpose programmable computer, including a desktop or a laptop computer, as well as a wireless telephone, PDA, or other device.

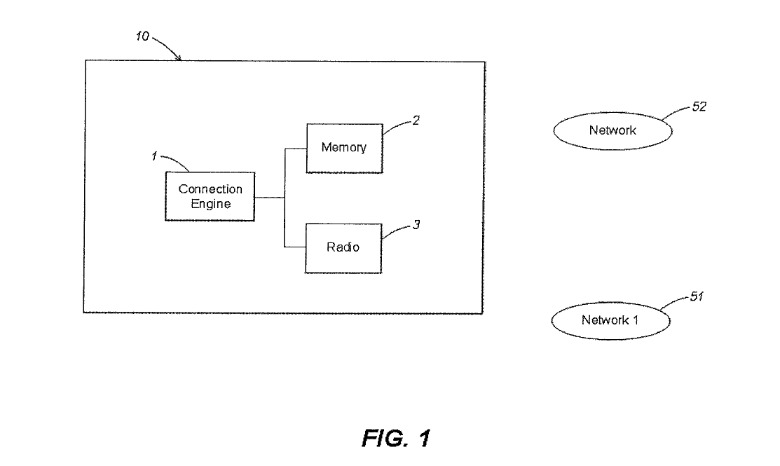

FIG. 1 shows a schematic block diagram of a computer 10 that is arranged in accordance with aspects of the invention. Although in this illustrative embodiment, only selected portions of the computer 10 are identified as being included in the computer 10, this is done for purposes of clarity and not to limit aspects of the invention in any way. For example, the computer 10 may include one or more additional volatile or non-volatile memories, a central processing unit, a display, a keyboard and/or other user input devices, as well as any suitable software or other instructions that may be executed by the computer 10 so as perform desired input/output or other functions.

In the illustrative embodiment, the computer 10 includes a connection engine 1 that can communicate with a memory 2 (e.g., a volatile or non-volatile RAM or other) and a radio 3 which may include a hardware controller such as a Network Interface Card (NIC) driver as well as suitable hardware such as a wireless radio card or other device. In the case where the computer 10 also communicates with wired networks, the radio 3 may also include a suitable driver and hardware for such communication.

FIG. 1 also shows two networks 51 and 52 with which the computer 10 may communicate via the radio 3. These networks 51 and 52 may take any suitable form, such as 802.11 wireless networks, devices configured to operate in a peer-to-peer network (or adhoc network), etc.

In accordance with an aspect of the invention, the connection engine 1 may store information regarding networks with which the computer 10 has connected with and/or networks with which the computer 10 is intended to connect with for communications. Such information is referred to herein as a network profile and may include the network name, security settings for the network, an encryption key or other similar information, a network type, etc. The information in a network profile may be provided in any suitable way, such as by the connection engine 1 obtaining some or all of the information in a network profile from the network itself, by a user manually entering or otherwise providing the information, and/or by a network administrator or other device sending the information to the connection engine 1, e.g., via a wired connection to the computer 10. The connection engine 1 may store the network profiles in any suitable way in the memory 2, such as in a database format, flat file, hierarchical file directory, etc.

In accordance with an aspect of the invention, one or more of the network profiles may be associated with an access period that defines how the network profile for the corresponding network will be maintained and/or define how the computer 10 will connect with the corresponding network. For example, the access period may define a period of time over which the network profile will be maintained in the memory 2 after a last connection of the computer 10 with the network. For example, the access period may define that the network profile is to be deleted from the memory 2 if more than a specified time period (such as one day, one week, one month, etc.) passes after the computer 10 last connected with the network. In one illustrative embodiment, the connection engine 1, upon connecting with a network, may establish a future date and time that the network profile for the corresponding network will be deleted if the computer 10 does not again reconnect with the network before the established date and time. If the future date and time are reached without a reconnection to the network, the connection engine 1 may delete the network profile from the memory 2. However, if the computer 10 reconnects with the network before the date and time are reached, the connection engine 1 may establish a new future date and time at which the network profile will be deleted. In this way, the connection engine 1 can ensure that “stale” or otherwise unused network profiles are deleted from the memory 2.

Those of skill in the art will appreciate that an access period established like that in the example above may be achieved in ways other than establishing a future date and time. For example, only a future date may be established and old network profiles may be deleted at any time after that date. For example, the connection engine 1 may only act to delete old network profiles at each time the computer 10 is started up. In such cases, the computer 10 may not actually be operating on the precise date and/or time on which a network profile is to be deleted. Instead, the connection engine 1 may determine that any network profile having an exhausted access period, whether on that day or on some past day, is to be deleted.

In another example, the access period may be established as an amount of time, such as one hour, ten hours, one day, etc. The connection engine 1 may count the access period time using a clock or other suitable means and take appropriate action, such as deleting the network profile, upon exhaustion of the access period. The clock regarding the access period may begin to count down (or up) when the network profile is first stored, when the computer 10 makes a first connection to the network, when the computer 10 disconnects from the network or based on any other suitable trigger.

In another example, the access period may establish a specified interval over which the computer 10 is permitted to connect with the corresponding network. For example, the access period may define a total amount of time that the computer 10 may be connected to the corresponding network, such as five minutes, thirty minutes, one day, etc. Thus, when the computer 10 is actually connected to the network, the connection engine 1 may count down (or up) the amount of connectivity time defined by the access period. Once the access period has been exhausted, the connection engine 1 may cause the computer 10 to disconnect from the network. Alternately, the connection engine 1 may delete the network profile for the network, potentially allowing the computer 10 to maintain its connection with the network (e.g., until the user causes a disconnection), but preventing any future reconnection with the network. Such an arrangement may be used, for example, with hotel guests who are provided with network profile information for a wireless or other network in a hotel room. The access period may allow for the computer's connection with the network for a specified amount of time, but prevent network access beyond that time. For example, the guest may be provided with an hour's worth of free network access, but may be required to pay for access beyond one hour. In another example, the interval defined by the access period may define a total number of bits, a total number of connections to the network, a total number of packets, that the computer 10 is to disconnect from a peer-to-peer network after a last peer has left the network for some period of time, and so on.

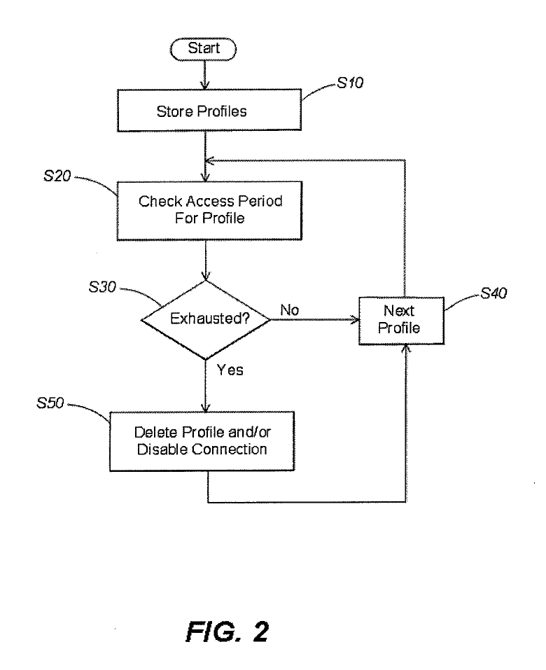

FIG. 2 shows a flow chart of steps and a method for managing network profiles and/or access periods for a network. In step S10, a network profile is stored for a plurality of networks. For example, the connection engine 1 in a computer 10 may receive profile information, such as the network name, security settings, authorization requirements, encryption codes, or other information, and store the network profile in any suitable way. The network profile information may be received by the connection engine 1 in the process of connecting with a network. Alternately, network profile information may be received from another source, such as a storage medium (e.g., an CD-ROM, flash memory, or other) via a wired network connection to an administrator which provides the profile information, or in other ways.

In step S20, an access period for a network profile may be checked. As discussed above, the access period may include a date and/or time at which the network profile is to be deleted. In other embodiments, the access period may define a total amount of time that the computer 10 may connect to the corresponding network, a total number of connections that may be made with the network, a total number of bits, packets or other measure of information sent and/or received over the network, and so on.

In step S30, the connection engine 1 may determine whether the access period for the network has been exhausted. For example, if the access period is defined by a date and time, the connection engine 1 may compare the current date and time to the access period date and time, and if the access period date and time has already passed, the connection engine 1 may delete the network profile. In another embodiment, if the access period defines a total number of connections that the computer 10 may make with the network, the connection engine 1 may compare the number of connections made with the network since the network profile was created to the number corresponding to the access period. (The connection engine 1 may keep track of network connections, incrementing a connection count variable for each connection.) If the number of connections actually made by the computer 10 to the network is equal to or exceeds the number in the access period, the connection engine 1 may delete the network profile and/or prevent the computer 10 from making future connections with the network. If the access period is not exhausted, flow continues to step S40, where the connection engine 1 continues step S20 with a next network profile and corresponding network.

However, if the access period is exhausted, flow continues with step S50, where the network profile is deleted and/or the computer 10 is caused to disconnect from the network (if connected) or further connection to the network is prevented. In some cases, the deletion of the network profile may prevent future connection to the corresponding network, e.g., because the computer may not have sufficient information to establish a connection (such as a network name, security code, etc.). However, in other embodiments, deletion of the network profile may not necessarily prevent future connection with the network (e.g., for open, unsecured networks), but instead may simply help to reduce the total number of stored network profiles as well as prevent the computer 10 from attempting to connect to the network in the future. Once the network profile has been deleted and/or connection to the network has been terminated, flow may continue to step S40 where a next network profile is assessed with respect to its access period.

The connection engine 1 may perform the steps shown in FIG. 2 at any suitable interval or event (such as each time the computer 10 is started, every day, every week, every time the computer disconnects from a network, and so on). In another embodiment, the steps shown in FIG. 2 may be performed every time the computer 10 attempts to connect with any network and/or at the command of a user.

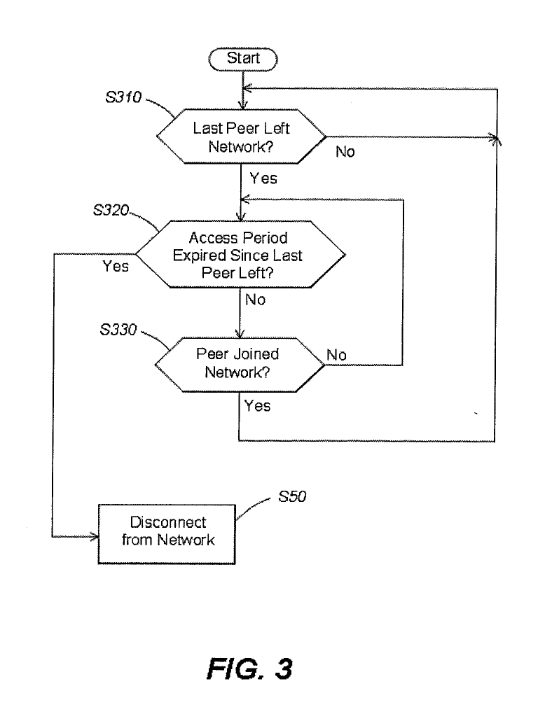

FIG. 3 shows a flow chart of steps in a method for managing an access period related to a peer-to-peer network that may be implemented in accordance with aspects of the invention. The steps shown in FIG. 3 may be performed as part of the implementation of steps S30 and S50 in FIG. 2. In step S310, a check may be made regarding whether the last peer in a peer-to-peer network has left the network. If at least one other peer aside from the computer 10 remains connected to the network, flow may recursively jump back to step S310. However, if a last peer has left the network, flow may continue to step S320 for a determination as to whether the access period for the network has been exhausted since the last peer left the network. For example, the access period may define that the computer 10 is to disconnect from the peer-to-peer network, zero seconds, ten seconds, one minute, ten minutes, etc., after a last peer has left the network. In this way, the computer 10 may be prevented from continually attempting to reconnect to other peers in the network even after all peers have departed. If the access period has not been exhausted, flow may jump to step S330 where a determination is made whether a peer has joined the network or not. If so, flow may jump back to S310. If not, flow may continue back to S320, where the connection engine 1 again determines whether the access period for the network has been exhausted. If the access period has been exhausted, flow may continue at step S50 where the computer may disconnect from the network and the network profile deleted from the system.

Aspects of the invention, including embodiments described above, can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one computer-readable medium (e.g., a computer memory, a floppy disk, a compact disk, a tape, etc.) encoded with a computer program (i.e., a plurality of instructions), which, when executed on a processor, performs the above-discussed functions of embodiments in accordance with aspects of the present invention. The computer-readable medium can be transportable such that the program stored thereon can be loaded onto any computer environment resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention. It should be appreciated that in accordance with several embodiments of the present invention wherein processes are implemented in a computer readable medium, the computer implemented processes may, during the course of their execution, receive input manually (e.g., from a user).

While aspects of the invention has been described with reference to various illustrative embodiments, the invention is not limited to the embodiments described. Thus, it is evident that many alternatives, modifications, and variations of the embodiments described will be apparent to those skilled in the art. Accordingly, embodiments of the invention as set forth herein are intended to be illustrative, not limiting. Various changes may be made without departing from the invention.

1. A method for managing wireless network profiles, comprising:
providing a computer constructed and arranged to communicate wirelessly with at least one other device in a wireless network;
storing one or more network profiles in a memory of the computer, each network profile including information regarding a corresponding wireless network that the computer has communicated with or is intended to communicate with and including at least a network name and a security setting of the wireless network, information in the network profile being useable by the computer in initiating a connection with the corresponding wireless network;
establishing an access period over which each of the network profiles will be maintained in the memory of the computer; and
deleting at least one network profile or disabling a connection to the corresponding wireless network when a corresponding access period for the network profile has been exhausted.

2. The method of claim 1, wherein the access period corresponds to a time period.

3. The method of claim 2, wherein the computer deletes the at least one network profile after determining that an amount of time corresponding to the time period has passed since the corresponding wireless network was last communicated with.

4. The method of claim 1, wherein the access period includes a date and time of day representing when the access period expires.

5. The method of claim 1, wherein the access period includes a number of connections that the computer may make with the corresponding wireless network.

6. The method of claim 1, wherein the access period is a connection period required for the computer to receive policy information needed by the computer for connecting to the corresponding network in a secure way.

7. The method of claim 1, wherein the access period defines a time period after which the computer is to disconnect from a network after the last network peer leaves the network.

8. The method of claim 1, wherein the access period corresponds to a time period, and the time period is reset when the computer connects to the corresponding network.

9. A computer readable medium including instructions that, when executed on a computer system, causes the computer system to perform a method, the computer system comprising a memory and at least one radio adapted for communication in a wireless network, the method comprising:
storing one or more network profiles in the memory, each network profile including information regarding a corresponding wireless network that the computer has communicated with or is intended to communicate with and including at least a network name and a security setting of the network, information in the network profile being useable by the computer in initiating a connection with the corresponding wireless network;
establishing an access period over which each of the network profiles will be maintained in the memory of the computer; and
deleting at least one network profile or disabling a connection to the network when a corresponding access period for the network profile has been exhausted.

10. A computer comprising:
a radio constructed and arranged to communicate with a wireless network;
a memory storing one or more network profiles, each network profile including information regarding a corresponding wireless network that the computer has communicated with or is intended to communicate with and including at least a network name and a security setting of the network, information in the network provide being useable by the computer in initiating a connection with the corresponding network; and
a connection engine that deletes a network profile in the memory and/or disables the radio from communicating with a network that corresponds to a network profile in the memory if an access period for the network has been exhausted.

11. The computer of claim 10, wherein the connection engine deletes the network profile and disables the radio from communicating with the corresponding network when the access period for the network profile is exhausted.

12. The computer of claim 10, wherein the access period corresponds to a time period.

13. The computer of claim 12, wherein the connection engine deletes the at least one network profile after determining that an amount of time corresponding to the time period has passed since the corresponding network was last communicated with by the radio.

14. The computer of claim 10, wherein the access period includes a date and time of day representing when the access period expires.

15. The computer of claim 10, wherein the access period is a number of connections that the computer may make with the corresponding network.

16. The computer of claim 10, wherein the access period is a connection period required for the computer to receive policy information needed by the computer for connecting to the corresponding network in a secure way.

17. The computer of claim 10, wherein the access period defines a time period after which the computer is to disconnect from a network after a last network peer leaves the network.

18. The computer of claim 10, wherein the access period corresponds to a time period, and the time period is reset when the computer connects to the corresponding network.

19. The computer of claim 10, wherein the access period corresponds to a time period, and the time period begins when the computer connects to the corresponding network.

20. The computer of claim 10, wherein the access period corresponds to a time period over which the computer is permitted to communicate with the corresponding network, and the connection engine causes the radio to disconnect from the network when the time period expires.
